(19) United States
(12) Patent Application Publication
(10) Pub. No.: US 2026/0260588 A1
(43) Pub. Date: Sep. 3, 2026

(54) CASE IDENTIFYING CLIP FOR ACCESSORIES

(71) Applicant: Moves Dance Studio, Inc., Carol Stream, IL (US)

(72) Inventors: Bryan Daniel Miedel, Wheaton, IL (US); Tenisha Marie Miedel, Wheaton, IL (US); Christopher Collins Weed, Wheaton, IL (US)

(21) Appl. No.: 19/551,469

(22) Filed: Feb. 26, 2026

Related U.S. Application Data
(60) Provisional application No. 63/765,109, filed on Feb. 28, 2025.

(51) Int. Cl. G09F 7/10; A45C 13/00; G09F 7/18

(52) U.S. Cl. CPC G09F 7/10; A45C 13/001; G09F 7/18

(57) ABSTRACT

Described herein are modular systems for removably attaching accessories (such as name plates) to cases (such as dance bags). Various embodiments include a clip portion configured to removably attach to a rigid portion of a dance bag. Such clips include at least one attachment mechanism, such as a T-shaped slot, to permit accessories (e.g., name plates, drink holders, or trays) to be interchangeably attached to the same. The accessories each include a corresponding structural element to removably attach to the attachment mechanism of the clip. In an embodiment where the clip has a T-shaped slot, the accessories include a protrusion that has a T-shaped cross section sized to fit snugly into the slot when the accessory is slid into the clip. The disclosed systems thus advantageously permit dancers to attach accessories to dance bags upon arrival at a competition, and to remove the same when the competition is over.

### PRIORITY CLAIM

This Application is a non-provisional of, claims the benefit of and priority to, and incorporates by reference herein, U.S. Provisional Patent Application Ser. No. 63/765,109, filed on Feb. 28, 2025.

### FIELD OF THE INVENTION

The instant disclosure relates to the field of clips and other attachment mechanisms for mounting accessories to the handles of cases, such as dance bags as are known in the dance industry.

### BACKGROUND

Personal carry items such as duffel bags, travel bags, youth athletic bags, and performance bags often include extendable handles, bars, rails, frames, or other rigid structural members used for handling, stacking, and storage. In certain such embodiments, the rigid portion (e.g., the handle) is extendable such that the bag can be easily moved between events.

In certain embodiments, particularly with respect to the dance industry, bags are configured to hold dance equipment (e.g., shoes, costumes, makeup, and the like) and, when the destination is reached, to expand in such a way as to allow easy access to the contents. For example, certain known dance bags have handles that pop up upon arrival at a competition, such that the bag can be opened and hanging costumes and other contents can be easily accessed while remaining hanging in the bag.

The inventors of the instant application have recognized a problem with such known bags. In particular, in a large event space (such as a large changing or dressing area), dozens or hundreds of dancers can have nearly identical bags set up with nearly identical contents. It can thus be difficult for dancers to readily locate their own bag, making it difficult or impossible to complete costume changes and other preparation in a timely fashion. Particularly where groups of dancers from the same studio may have identical costumes, simply in different sizes, it is highly problematic that all bags look nearly identical.

In addition, while dance bags can be advantageously expanded to reveal their contents, they nevertheless lack surfaces on which to place items such as makeup or drinks while a dancer changes costumes or otherwise prepares to perform.

Accordingly, a need exists for a system for affixing accessories, such as name plates, cup holders, or trays, to an expanded carrying case (such as a dance bag) in a removable fashion. A need exists for such a system to be readily assembled when arriving at a venue, and to be readily disassembled prior to leaving the venue.

### SUMMARY

Described herein are various embodiments of clips and attachments to the same for use in removably attaching accessories to the handles of cases. In certain embodiments, the clips are configured to removably attach to the extendable handles of known dance bags. In these embodiments, accessories can be affixed to the clips after the clips are affixed to the dance bag. For example, a name plate bearing a dancer's name may be slid into a T-shaped slot in the clip, such that the name plate can be affixed to the bag when the bag is set up in a large room. Advantageously, certain embodiments of the clips and accessories disclosed herein permit the easy identification of a dancer's bag in a large room full of similar or identical bags, such as in a changing area at a dance competition.

In various embodiments of the system disclosed herein, one or more clip portions is modular and removably attachable to the handle of a dance bag when that handle is in its extended position. In such embodiments, the clip partly encircles the handle portion, and has a cross section that prohibits the clip from rotating when mounted to the handle.

In various embodiments, the clip includes an attachment mechanism, such as a T-shaped slot, a pressure fitting, magnets, or other appropriate mechanism, to permit various accessories to be removably mounted to the clip. Such accessories may include name plates, cup holders, trays, or other accessories as described herein. The accessories each include a portion designed to mate with the attachment mechanism of the clip. For example, if the clip has a T-shaped slot, each accessory may have a T-shaped protrusion that can slide into the slot to mount the accessory to the clip.

In this way, the clip/accessory combination can be changed as accessory needs changed, and the clip can be mounted to the handle of a dance bag, such that the accessory can perform its function. For example, if the accessory is a name plate, a dancer can arrive at a venue, set up her dance bag in a changing or staging area, affix a clip to the handle, and affix her name plate to the clip. This permits the dancer (and/or coaches or parents) to readily identify her bag in a large room full of nearly identical bags, enabling quick changes of costume or other activities that can be time sensitive in connection with a dance competition.

In certain embodiments, multiple clips with differing cross sections can be provided in a modular fashion such that each clip is attachable to each of a plurality of accessories. Thus, one clip may fit the handle for one bag brand, and another may fit the handle for another bag brand. Additionally or alternatively, one clip may fit a portion of an extendable frame (e.g., a horizontal bar) and another clip may fit a different potion of that same extendable frame (e.g., a vertical bar).

In certain embodiments, different attachment mechanisms are disclosed for mounting an accessory to a clip. For example, in some embodiments, magnets may be used such that the clip and the accessory have corresponding magnets (e.g., of opposite polarities) arranged in such a way as to permit removable attachment of the accessory to the clip. In certain embodiments, the clips have a slot whose cross section is not t-shaped, and the accessories have a protrusion that corresponds to the cross section of the slot. Certain embodiments include multiple attachment mechanisms, such as a t-shaped slot and magnets on the clip, a t-shaped protrusion and magnets on the accessory. In these embodiments, accessories can be removably attached by engaging the mechanisms as appropriate, such as by sliding a protrusion into a slot until the magnets are aligned to resist removal of the same.

The inventions described herein have applicability in a number of industries, including dance, travel (e.g., a cup holder that can mount to a suitcase while a passenger waits to board a plane), other sports (e.g., bags for holding baseball equipment), and the like. It should be appreciated that the systems disclosed herein advantageously provide: (i) a standardized modular docking solution to mount multiple accessories to a rigid structure; (ii) cross-compatibility of modules across multiple clip-body geometries; (iii) passive retention without added hardware to an existing rigid frame, such as an existing, extendable handle; and/or (iv) ecosystem scalability enabling new accessories without redesigning the clip body. This enhances manufacturing capability as well, as clips may be bulk manufactured while accessories may be made on a more custom basis (e.g., with different names, for different sized drinks, in different colors, etc.).

### BRIEF DESCRIPTION OF THE DRAWINGS

FIGS. 1A-1I illustrate different views of an embodiment of a clip according to the present disclosure.

FIG. 2 illustrates an exemplary name plate accessory for mounting on a clip as described in the present disclosure.

FIG. 3 is an example of a connector to join a clip and an accessory together as described in the present disclosure.

FIG. 4 is an example of an accessory (specifically, a cup holder) that can be mounted to the clip disclosed herein.

FIGS. 5A-5I illustrate different views of an alternative embodiment of a clip according to the present disclosure.

FIGS. 6A-6I illustrate different views of an alternative embodiment of a clip according to the present disclosure.

FIGS. 7A-7I illustrate different views of an alternative embodiment of a clip according to the present disclosure.

FIGS. 8A-8I illustrate different views of an alternative embodiment of a clip according to the present disclosure.

FIGS. 9A-9I illustrate different views of an alternative embodiment of a clip according to the present disclosure.

FIGS. 10A-10I illustrate different views of an alternative embodiment of a clip according to the present disclosure.

FIGS. 11A-1II illustrate different views of an alternative embodiment of a clip according to the present disclosure.

FIGS. 12A-121 illustrate different views of an alternative embodiment of a clip according to the present disclosure.

FIGS. 13A-13I illustrate different views of an alternative embodiment of a clip according to the present disclosure.

FIGS. 14A-14I illustrate different views of an alternative embodiment of a clip according to the present disclosure.

FIGS. 15A-15I illustrate different views of an alternative embodiment of a clip according to the present disclosure.

FIGS. 16A-16I illustrate different views of an alternative embodiment of a clip according to the present disclosure.

FIGS. 17A-17I illustrate different views of an alternative embodiment of a clip according to the present disclosure.

FIG. 18 illustrates a tray according to an embodiment of the present disclosure,

FIG. 19 illustrates a hook according to an embodiment of the present disclosure, and FIG. 20 illustrates a cell phone holder according to an embodiment of the present disclosure.

### DETAILED DESCRIPTION

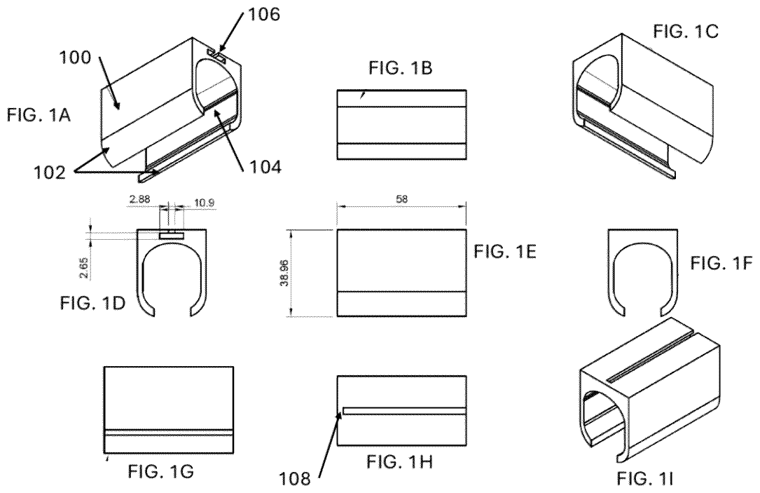

FIGS. 1A-1I illustrate different views of one embodiment of the clip disclosed herein. In connection with FIG. 1A, the clip 100 is illustrated in a perspective view. Clip 100 includes, in this embodiment, a pair of deformable arms 102 that are each formed of the same material as the body of the clip 100. Each arm is configured to flex outward when the clip is mounted to a rigid item, such as a handle of a dance bag. In the illustrated embodiment, the handle of the dance bag for which the clip is configured has a cross section shaped to match the cross section 104 of the clip 100. The cross section 104 is more clearly visible, for example, in FIGS. 1D and 1F, which are respective end views of the clip 100 shown in FIGS. 1A-1I.

When the clip is mounted to a handle, the arms 102 flex outward upon installation and then resiliently flex inward again to secure the clip to the handle. As can be appreciated, given that the cross section 104 is asymmetrical, the clip cannot rotate when mounted to the handle. Accordingly while the clip is removably mountable to a handle by pushing it onto the handle, it will not rotate in ordinary use after installation. In alternative embodiments, corners in the clip (and corresponding corners in the handle to which it mounts) prevent the clip from inadvertently rotating when installed on the handle.

Clip 100 also includes a T-shaped slot 106 for mounting accessories to the clip 100. The T-shaped slot 106 runs along a longitudinal dimension of the clip 100, and in the illustrated embodiment does not all the way along the extent of that longitudinal dimension. Instead, the T-shaped slot 106 is only provided for a portion of the longitudinal dimension of the clip 100, such that when an accessory is mounted into the T-shaped slot as will be described, it cannot be pushed all the way through the T-shaped slot. The portion of the clip 100 that prohibits such inadvertent pushing is illustrated as item 108 in FIG. 1H. This permits a user to mount the accessory firmly, but not to push the accessory through the slot 106 and out the other side of the clip 100.

FIG. 1C is a perspective view of the clip 100 from the other side than the one illustrated in FIG. 1A. It should be appreciated that the T-shaped slot 106 is not visible in FIG. 1C, indicating that the slot does not extend all the way along the longitudinal dimension of the clip 100. The extent of the slot can be seen in FIG. 1H, which is a top view of the clip 100, by virtue of portion 108. Likewise, FIG. 1I, which is a top perspective view of the clip 100, illustrates the extent to which the slot is provided along the longitudinal dimension of the clip 100.

FIG. 1B is a bottom view of the clip 100. FIGS. 1E and 1G are side views of the clip 100. FIGS. 1D and 1F are end views of the clip 100, with FIG. 1D illustrating the slot 106 and FIG. 1F not illustrating the slot 106, indicating that the slot does not extend through the entirety of the longitudinal dimension of the clip 100.

FIGS. 1D and 1E include exemplary dimensions for the clip 100 and the various portions of the T-shaped slot 106 in millimeters. It should be appreciated that these dimensions are exemplary, and may vary depending on the application, the size of the clip, or the weight of the accessory to be mounted.

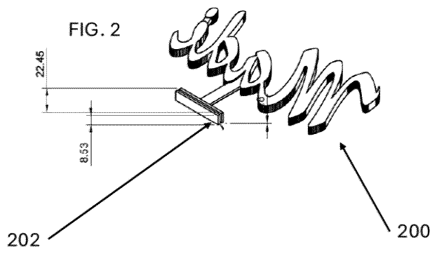

FIG. 2 is an example of an accessory in the form of a name plate 200 that can be mounted to clip 100 as described in connection with FIGS. 1A-1I. As can be seen, accessory 200 includes an extension 202 that has a T-shaped cross section sized to fit tightly into the T-shaped slot 106 of FIGS. 1A-1I. In this embodiment, the extension 202 can be slid into the slot 106 and pushed until it hits the end of the slot 106; in this way, the accessory 200 cannot be “over inserted.” In an embodiment, the manufacturing tolerances and materials of the slot 106 and the extension 202 are such that friction prevents inadvertent dislodgment of the accessory 200. In this embodiment, by pushing the accessory 200 in the opposite direction from the direction of insertion, it can be removed as desired by a user. In certain embodiments, the clip 100 and the accessory 200 are formed from plastic. In certain embodiments, one or more of clip 100 and accessory 200 is 3D printed. In certain embodiments, one or more of clip 100 and accessory 200 is injection molded. In one embodiment, the clip 100 and the accessory are made of different materials, where one is made of metal and the other is made of plastic.

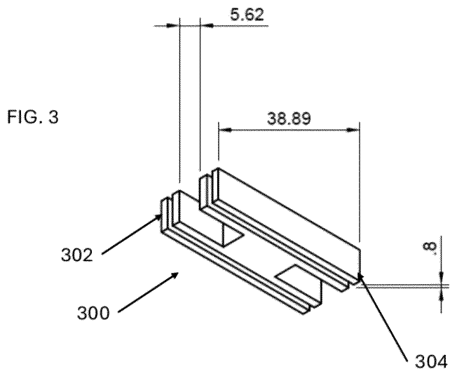

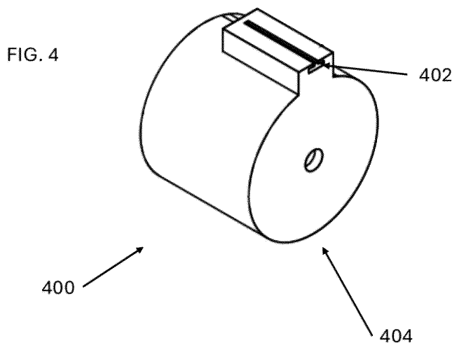

FIG. 3 illustrates a connector 300 that is configured to connect to a clip and to an accessory. In particular, connector 300 includes two T-shaped extensions 302 and 304, wherein each T-shaped extension is configured to be mounted inside a T-shaped slot such as the slot 106 of FIGS. 1A-1I. In the context of FIG. 3, the other one of the T-shaped extensions (i.e., the one that does not mount in the T-shaped slot 106 of a clip 100) can be inserted into a similarly shaped and sized T-shaped slot of an accessory, such as the cup holder described in more detail below with respect to FIG. 4. In this configuration, the connector 300 (which may be referred to as an “H shaped connector”) can be used to connect two items (e.g., a clip and an accessory) that each include a T-shaped slot. In addition to each T-shaped connector creating an H-shaped cross section, in this embodiment the connector 300 itself has the footprint of a capital letter “H.”

In one embodiment, the connector 300 has two T-shaped extensions disposed from one another at a 180-degree angle, as shown in FIG. 3. In this embodiment, the connector 300 has an H-shaped cross section. In other embodiments, the connector includes a structure in between the two T-shaped extensions, such that it has the cross section of two capital E's back-to-back. In certain embodiments, the T-shaped extensions are disposed at other than a 180-degree angle to one another, such that the accessory is positioned at an angle to the underlying clip. In some embodiments, the connectors 302 and 304 do not have a T-shaped cross section, but rather have a different cross section (or a different connection mechanism altogether) as described elsewhere herein.

FIG. 4 illustrates a cup holder accessory 400 for use with the clip 100 of FIGS. 1A-1I. In this embodiment, the accessory 400 has a T-shaped slot 402 and an accessory portion 404, which in the illustrated embodiment is a cup holder. In this embodiment, the cup holder accessory 400 is connected to a clip (such as clip 100) by using a connector 300 as shown in FIG. 3. The connector 300 engages the slot 106 of the clip, and the slot 402 of the accessory, to join those two parts together. This can be achieved with the illustrated connector 300, or any alternative design as described elsewhere herein.

In certain embodiments, the cup holder accessory 400 includes a T-shaped connector extending therefrom, such as the connector 202 illustrated in FIG. 2 in connection with the name plate accessory 200. In this embodiment, the cup holder accessory 400 can connect directly to a clip 100 without needing to use an intervening connector (such as H-shaped connector 300).

In various embodiments, the accessory is not a cup holder but is something else that could be usefully attached to a clip of a case, such as a dance bag. For example, the accessory may be a mirror, a tray (e.g., for holding hair accessories), a mobile device holder, or a fan. In such embodiments, the accessory may either have its own T-shaped slot (or other mounting mechanism as disclosed herein), and may rely on a connector such as connector 300 to mount to the slot in a clip affixed to a case handle. The accessory may alternatively have an extension with a T-shaped cross section that is configured to engage with the T-shaped slot of the clip.

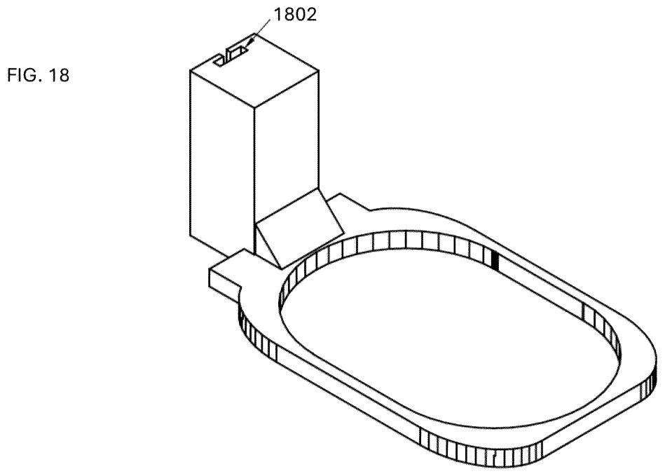

FIG. 18 is an embodiment of an accessory that takes the form of a tray, for example a tray for holding bobby pins. As can be seen, the embodiment of FIG. 18 includes a T-slot 1802, meaning that to mount to a clip at least one T-shaped extension (either in the form of a connector or on the clip itself) would be required.

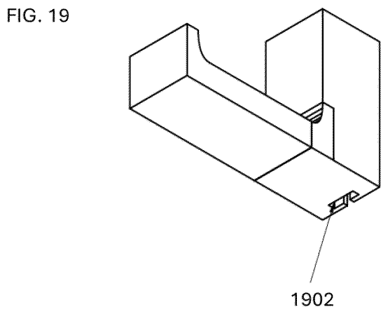

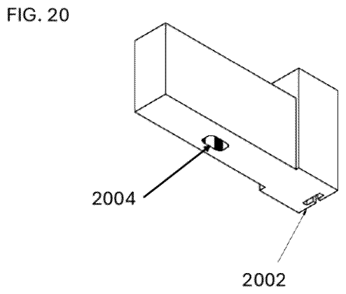

FIG. 19 is an embodiment of an accessory that takes the form of a hook, for example a hook to hang a bag or a piece of clothing. As can be seen, the embodiment of FIG. 19 includes a T-slot 1902, meaning that to mount to a clip at least one T-shaped extension (either in the form of a connector or on the clip itself) would be required.

FIG. 20 is an embodiment of an accessory that takes the form of a cell phone holder/charger. As can be seen, the embodiment of FIG. 20 includes a T-slot 2002, meaning that to mount to a clip at least one T-shaped extension (either in the form of a connector or on the clip itself) would be required. In this embodiment, opening 2004 is provided so that a cord can be plugged into a cell phone while it is being charged, and the shape of the inside of the holder is sized to match the bottom of a conventional cellular telephone.

In certain embodiments, the clip disclosed herein includes a T-shaped extension, and the accessory has a slot configured to engage the extension of the clip. In certain embodiments where the clip has a T-shaped extension and the accessory also has a T-shaped extension, a connector that is shaped to accept two T-shaped extensions may be provided. The cross-section of such a connector may look like two capital C's positioned back-to-back.

Many of the embodiments described above discuss a T-shaped design, whereby a T-shaped extension is insertable into a T-shaped slot. It should be appreciated that the instant disclosure is not limited to T-shaped slots/extensions, and other shapes are contemplated herein. For example, a slot that has the cross section of a “lollipop,” with a circle and a stem portion, may be used in various embodiments. In some embodiments, the cross section of the slot and extension are arrowhead shaped, with a triangular component and a stem component extending therefrom. Other shapes that permit easy slidable engagement and disengagement are also contemplated herein; the presence of a shoulder portion and a narrower connecting portion to prevent the connection from separating laterally (while sliding longitudinally) is at the heart of aspects of this disclosure.

In various other embodiments, other connection mechanisms are contemplated beyond the slot/extension mechanisms described above. In certain embodiments, the connection mechanisms described are augmented or replaced by latches, detents, snap-fits, magnets, fasteners, or spring elements. In some embodiments, for example, a plurality of magnets are provided such that the magnets resist separation of a clip and an accessory. In one such embodiment, one or more magnets are positioned in the clip, and one or more other magnets are positioned in the accessory, such that when the two are mated the magnets present a force opposing sliding separation of the same. In other embodiments, where metal is used in construction of either the clip or the accessory, magnets and metal interact to resist sliding engagement of the two components.

In alternative embodiments, the clip body may be configured to engage structural members of varying size and shape, including members with circular, oval, rectangular, or compound profiles. In certain embodiments, the interface may be positioned on a front face, side face, or top face of the clip body, provided that the interface remains standardized for module cross-compatibility.

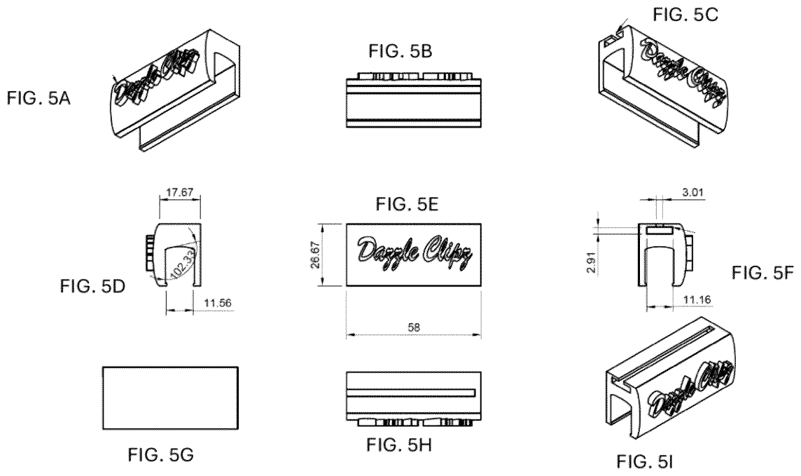

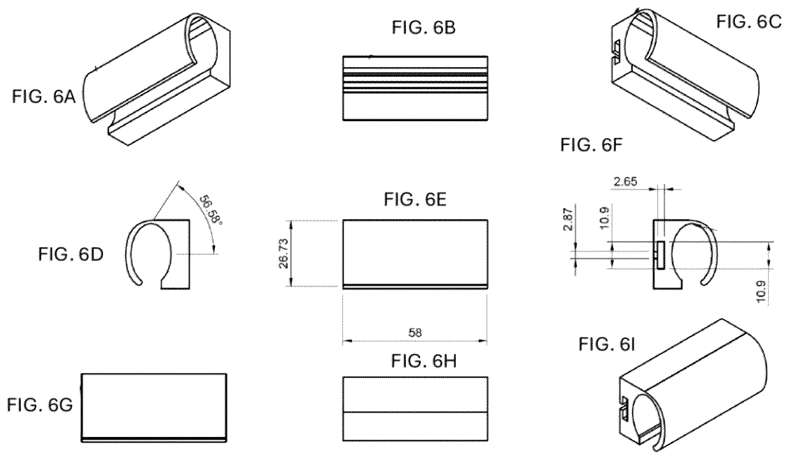

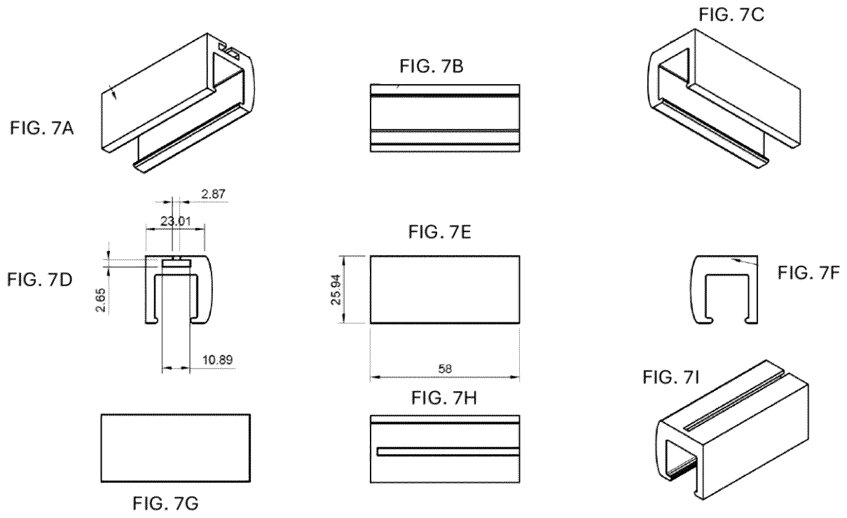

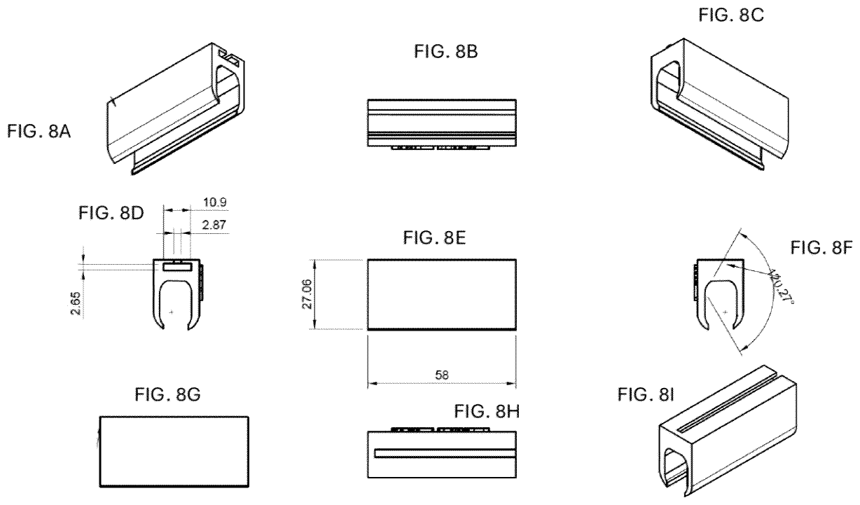

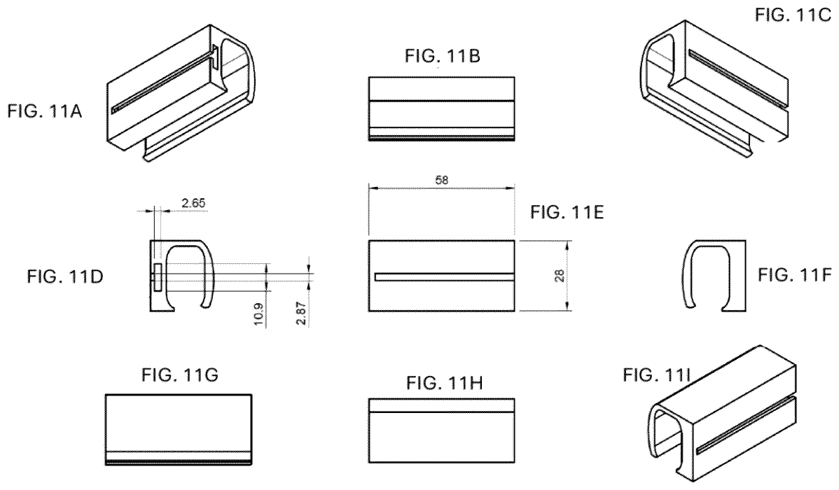

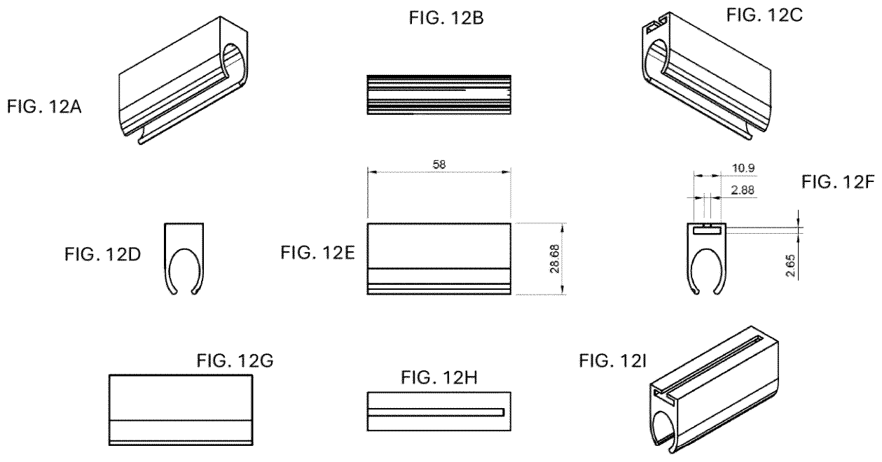

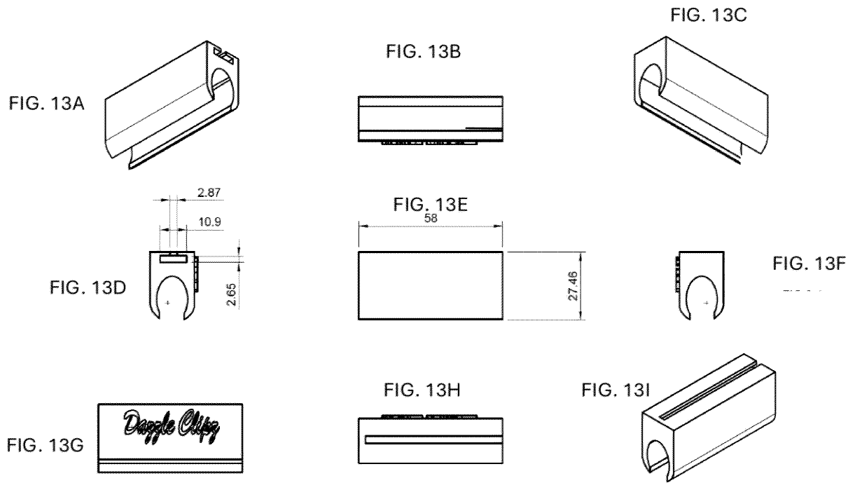

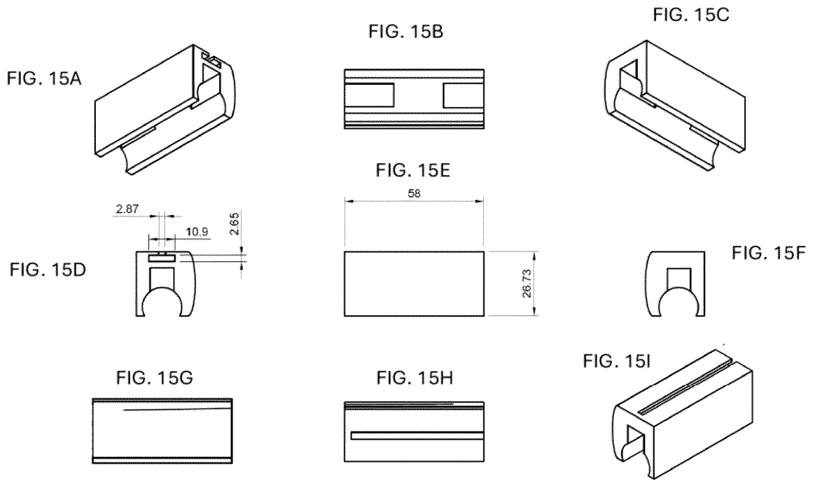

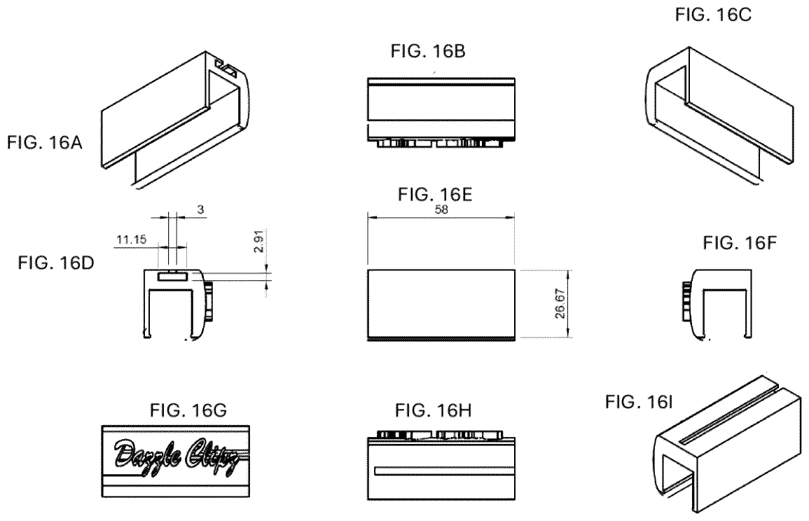

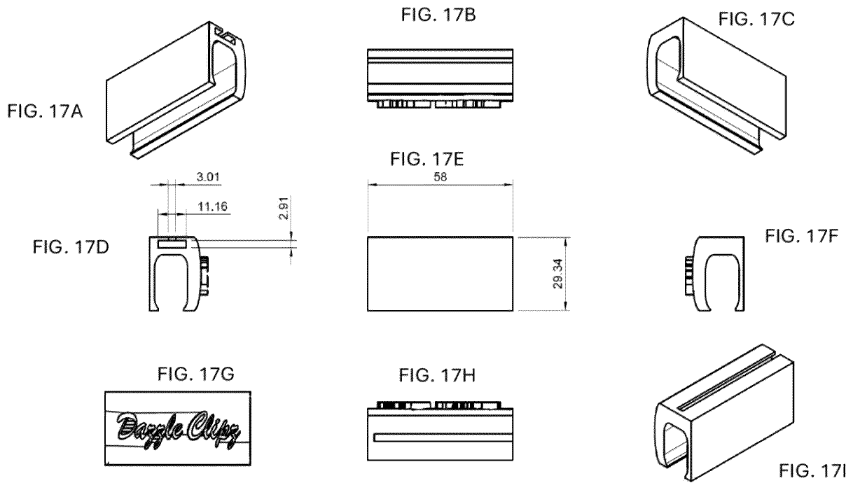

FIGS. 5A-5I, 6A-6I, 7A-7I, 8A-8I, 9A-9I, 10A-10I, 11A-11I, 12A-12I, 13A-13I, 14A-14I, 15A-15I, 16A-16I, and 17A-17I illustrate alternative embodiments of clips according to the present disclosure. In each set of figures, the “A” version and the “C” version are bottom perspective views, the “B” version is a bottom view, the “D” and “F” versions are end views, the “E” and “G” versions are side views, the “H” view is a top view, and the “I” view is a top perspective view.

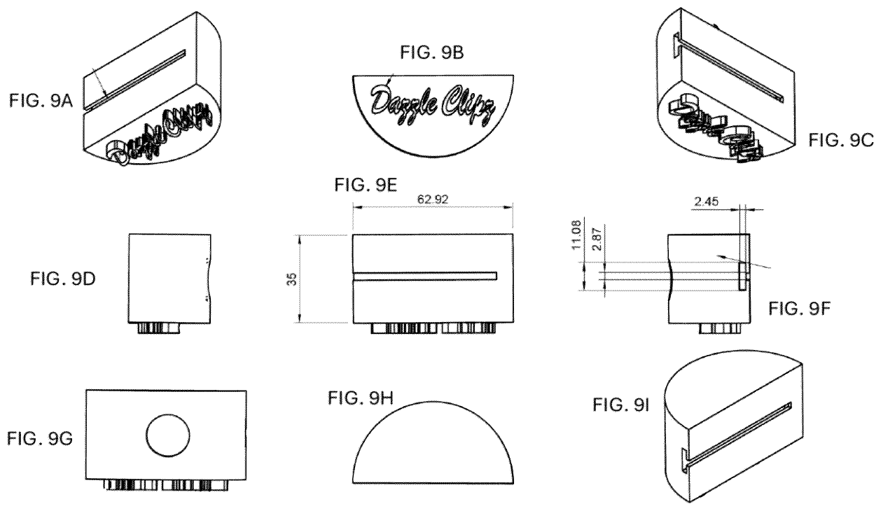

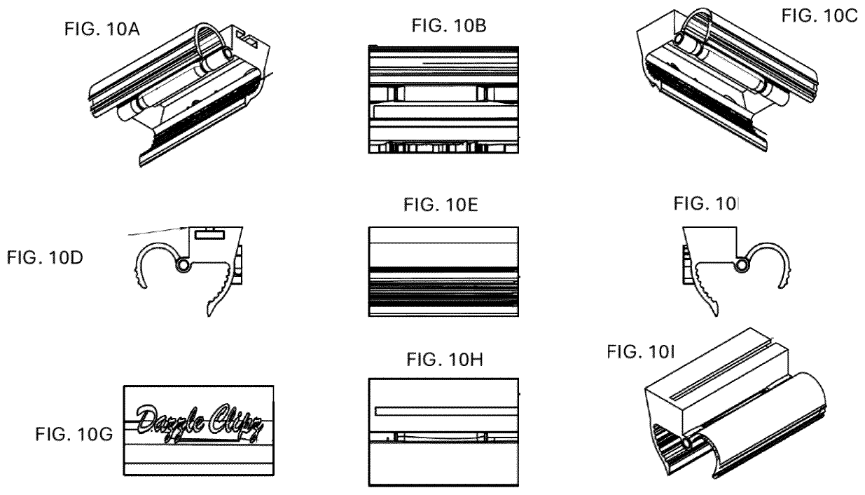

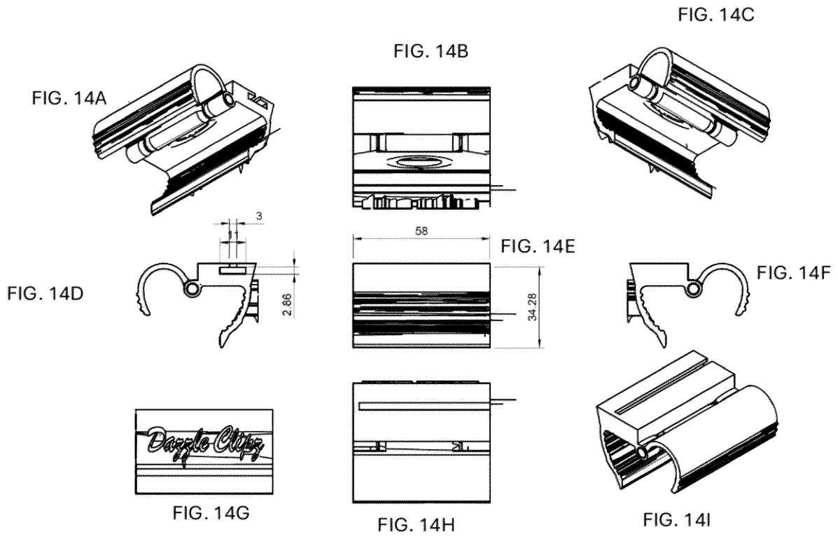

In particular, in these drawings the clips are sized and shaped to engage with handles or other rigid frame structures of known cases/dance bags. Certain of these designs, based on the rigid structures to which they connect, rely on an opening-and-closing mechanism such that the clip can be opened, positioned around a handle, and closed to engage with the handle of the particular bag. For example, FIGS. 10A-10I and FIGS. 14A-14I depict a clip that can open and close around the handle of a dance bag. FIGS. 9A-9I, to the contrary, illustrate a clip that does not encircle a longitudinally extending handle, but rather mounts to a vertically oriented pole extending upward from an appropriate case. It should be appreciated that the disclosed systems can be adapted to mount to any appropriate dance bag or other case within the spirit and scope of the inventions disclosed herein.

In further embodiments, the clip body may incorporate internal reinforcement ribs, lattice structures, honeycomb regions, or solid-core regions to tune stiffness, compliance, impact resistance, and weight. In some embodiments, a modular insert may be used to vary internal engagement geometry while preserving the same external interface.

Unless otherwise indicated, all numbers expressing quantities of ingredients, properties such as molecular weight, reaction conditions, and so forth used in the specification and claims are to be understood as being modified in all instances by the term “about.” This includes dimensions stated or implied in the specification or the drawings submitted herewith. Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

It is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

We claim:

1. An accessory mounting system comprising:
a clip having an asymmetrical cross section and a t-shaped slot portion running along a longitudinal axis; and
an accessory including a t-shaped protrusion sized for insertion into the t-shaped slot portion of the clip, such that when inserted the clip and the accessory resist separation without requiring additional mounting hardware.

2. The accessory mounting system of claim 1, wherein the asymmetrical cross section is sized and shaped to engage a handle portion of a case.

3. The accessory mounting system of claim 2, wherein the case is a dance bag and the handle portion extends upward when the dance bag is open.

4. The accessory mounting system of claim 1, wherein the accessory is one selected from the group consisting of a name plate, a drink holder, a fan, a mirror, a mobile device case, and a tray.

5. The accessory mounting system of claim 1, wherein the clip includes a logo running along a longitudinal surface of said clip.

6. The accessory mounting system of claim 1, which comprises at least two accessories selected from the group consisting of a name plate, a drink holder, a fan, a mirror, a mobile device case, and a tray.

7. The accessory mounting system of claim, further comprising a case having a handle portion sized to engage the cross section of the clip.

8. An accessory mounting system comprising:
a clip having an asymmetrical cross section that matches a cross section of a handle of a case and an attachment mechanism oriented along a longitudinal axis of the clip; and
an accessory including a feature configured to mate with the attachment mechanism to permit mounting of the accessory to the clip via the attachment mechanism; wherein
the attachment mechanism and the feature do not require additional hardware to secure the accessory to the clip.

9. The accessory mounting system of claim 8, wherein the case is a dance bag and wherein the handle extends upward when the dance bag is open.

10. The accessory mounting system of claim 8, wherein the accessory is one selected from the group consisting of a name plate, a drink holder, a fan, a mirror, a mobile device case, and a tray.

11. The accessory mounting system of claim 8, wherein the clip includes a logo running along a longitudinal surface of said clip.

12. The accessory mounting system of claim 8, which comprises at least two accessories selected from the group consisting of a name plate, a drink holder, a fan, a mirror, a mobile device case, and a tray.

13. The accessory mounting system of claim 8, further comprising a case having a handle sized to engage the cross section of the clip.

14. The accessory mounting system of claim 8, wherein the attachment mechanism is a t-shaped slot and the mounting feature includes a protrusion with a t-shaped cross section.

15. The accessory mounting system of claim 8, wherein the attachment mechanism includes at least one magnet and the mounting feature includes at least one magnet of opposite polarity.

16. The accessory mounting system of claim 8, where the attachment mechanism is a slot having a defined cross section, and wherein the mounting feature is a protrusion having said defined cross section.

17. The accessory mounting system of claim 1, wherein the clip includes a pair of deformable arms that can expand and thereafter contract around a handle as the clip is installed on said handle.

18. The accessory mounting system of claim 8, wherein the clip includes a pair of deformable arms that can expand and thereafter contract around the handle as the clip is installed on said handle.
